(19) United States
(12) Patent Application Publication
(10) Pub. No.: US 2026/0219229 A1
(43) Pub. Date: Jul. 30, 2026

(54) ANALYTE DETECTION APPARATUS

(71) Applicant: NUTROMICS TECHNOLOGY PTY LTD, BRUNSWICK , VICTORIA (AU)

(72) Inventors: AGIM BESHIRI, BRUNSWICK, VICTORIA (AU); MIKEL LARSON, BRUNSWICK, VICTORIA (AU)

(21) Appl. No.: 19/146,448

(22) PCT Filed: Nov. 20, 2023
(86) PCT No.: PCT/AU2023/051179

§ 371 Date: Jul. 8, 2025

Related U.S. Application Data
(60) Provisional application No. 63/437,806, filed on Jan. 9, 2023.

(51) Int. Cl. G01N 27/327; G01N 27/28

(52) U.S. Cl. CPC G01N 27/3276; G01N 27/286

(57) ABSTRACT

A sample contacting component of a sample analysing apparatus or system. The sample contacting component has an electrochemical aptamer-based sensor associated therewith to contact a sample within or about the sensor.

### FIELD OF THE INVENTION

The present invention relates generally to the in vitro detection of an analyte in a clinical sample, involving taking a biological fluid from a subject for testing in a laboratory. The present relates also to the detection of an analyte in a clinical sample at a point-of-care. More particularly, the invention is directed to improvements in hardware used in such detection methods.

### BACKGROUND TO THE INVENTION

Laboratory-based analyte detection methods are undoubtedly an essential part of modern medicine. These methods provide clinicians with important information on a patient to assist in diagnosing a new medical condition, managing an existing condition, assisting in prognosis, or otherwise providing clinically relevant information.

In many cases the detection method determines the level of an analyte in a blood sample taken from the patient. Exemplary analytes detectable in blood include glucose and haemoglobin A1c (for diabetes), calcium (for kidney disease), troponin and cholesterol/lipids (for heart disease), prostate specific antigen (for prostate cancer), D-dimer (for clotting disorders), and C-reactive protein (for infection and inflammatory disorders).

Fluids other than blood may be used as a sample for analytical methods including urine, saliva, cell and tissue lysates, alveolar washes, cerebrospinal fluid, and semen.

Some analyte detection methods are not performed in the context of any disease state any disease state and include methods for the detecting reproductive hormones in pregnancy, antibodies showing seroconversion after administration of vaccine, and dietary factors such as folate and vitamin D.

Analytes that are exogenous to the patient may be the subject of detection methods. Common analytes in that regard include viral and bacterial proteins, drugs (prescribed and illicit), environmental toxins, and the like.

Typically, the first step is obtaining a clinical sample at the bedside or in the clinic, with the clinician ordering one or more diagnostic methods to be performed on the sample.

The sample is accorded a unique identifier, and couriered to a competent laboratory for assay of the relevant analyte(s).

Current state of the art laboratories are essentially automated facilities that rely on robotic means for handling clinical specimens. A clinical sample will generally pass through multiple robotic workstations to perform processes such as sample preparation, addition of reagents, removal of reagents, and obtaining test outputs. These process include a large number of liquid transfer steps (often by way of automated pipetting), incubating steps, washing steps, absorbance or absorbance measuring steps, movement of a sample from one workstation to another, et cetera.

Various infrastructure services required in laboratories include water treatment units to generate DI water, specialised plumbing to accommodate waste.

Each step typically requires dedicated equipment and reagents which add greatly to the cost of laboratory investigations. Some reagents used in laboratory analysis are toxic, carcinogenic, or otherwise hazardous to humans.

Each step in a laboratory test introduces the possibility of an error, leading to potentially erroneous information being provided to the clinician. Moreover, the need for multiple steps results in significant delay in providing results.

A further problem arises where multiple analytes are to be detected in a sample. In such circumstances it is typical for a relatively large volume of blood or other relevant fluid is obtained from the subject. In the laboratory, the volume is divided into a number of aliquots with each aliquot being tested for a single analyte. This approach may be unworkable where a large sample is not available, and in any event adds cost and complexity.

An example of laboratory-based test of moderate complexity is found in the enzyme immunoassay (EIA) for antibody to hepatitis B surface antigen (anti-HBs) in serum. This EIA is a solid phase assay reliant on the “sandwich principle” to detect the antibodies. An abridged version of the relevant protocol follows.

Polystyrene beads coated with human Hepatitis B Surface Antigen (HBsAg) are incubated with either the patient specimen or the appropriate controls. During incubation, antibody, if present, is immunologically coupled to the solid phase antigen. After removal of the unbound material and washing of the bead, human HBsAg tagged with biotin (B-HBsAg) and rabbit anti-biotin, conjugated with horseradish peroxidase (anti-H-HRPO), are incubated with the antibody-antigen complex on the beads. The biotinylated surface antigen binds to this complex crating an antigen-antibody-antigen “sandwich”. The anti-biotin horseradish peroxidase binds to the biotin component of the “sandwich”, forming a solid phase network. Unbound conjugates are removed, and the beads are washed. Next, o-Phenylenediamine (OPD) solution containing hydrogen peroxide is added to the bead, and after incubation, a yellow colour develops in proportion to the amount of anti-HBS which is bound to the bead. Within limits, the greater the amount of antibody in the sample, the higher the absorbance. The enzyme reaction is stopped by the addition of acid. The absorbance of controls and specimens is determined using a spectrophotometer with wavelength set at 492 nm.

As will be readily appreciated, even the abridged outline above demonstrates the need for a large number of reagents, multiple items of equipment, many dedicated steps, and an extended period of time to complete. The actual step-by-step protocol for the assay is significantly more involved, evidencing greater complexity still.

High throughput analytical laboratories comprise rooms full of equipment, each of which has an associated purchase/lease cost, operating cost, maintenance cost, repair cost and personnel cost. There is further cost in the purchase and storage of reagents, washing solutions and other consumables. Such facilities are therefore extremely expensive to establish and operate, with the associated costs being passed on the relevant government health department, health insurer or consumer/patient.

A further problem in analytical laboratories is the lack of flexibility in established workflows. As one example, a sample for a subject may require analysis for three analytes and in which case the sample is split into three aliquots, with each aliquot being batched with other samples for the same test. In some cases, a test batch must be run at less than the maximum number of available sample spaces so as to ensure results are timely provided. Running a test at less than its full capacity of sample may be wasteful of reagents and equipment resources.

A further problem is the need for a procedurally simple and rapid point-of-care test for use in hospitals and other health care facilities. Patient-facing personnel typically lack the expertise, equipment, and time to perform complex analytical tests. For example, it may be desirable for a doctor to instantly assess the level of a therapeutic drug in a patient's blood so as to ensure the concentration is within a therapeutic window. Drug levels are normally sent to an analytical laboratory with a result being returned after a delay of possibly several hours. By the time the doctor reviews the results, the drug will have inevitably changed, and so corrective action may be too late.

It is an aspect of the present invention to provide an improvement to prior art laboratory-based or point-of-care analyte detection. It is a further aspect of the present invention to provide a useful alternative to prior art laboratory-based or point-of-care analyte detection.

The discussion of documents, acts, materials, devices, articles, and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a sample contacting component of a sample analysing apparatus or system, the sample contacting component having an electrochemical aptamer-based (EAB) sensor associated therewith configured to contact a sample within or about the sensor.

In one embodiment of the first aspect, the sample contacting component is a consumable, removable or interchangeable component of a sample analysing apparatus or system.

In one embodiment of the first aspect, the sample contacting component is a vessel, a liquid conduit or a probe of a sample analysing apparatus or system.

In one embodiment of the first aspect, the vessel is a tube or a well, and the liquid conduit is a pipette.

In one embodiment of the first aspect, the EAB sensor comprises a working electrode.

In one embodiment of the first aspect, the working electrode is in the form of a wire, a liner, a foil, a plate, a grid, a cage, a pin, or a needle.

In one embodiment of the first aspect, the sample contacting component comprises an electrical conduit in electrical connection with the working electrode.

In one embodiment of the first aspect, the electrical conduit extends from the working electrode to an edge of the component.

In one embodiment of the first aspect, the electrical conduit has a terminus distal to the working electrode and the terminus forms a first interface portion or is in electrical connection with a first interface portion, the first interface portion being configured to make electrical connection with a second interface portion of a mounting component of the apparatus or system, the mounting component being configured as a mount for the sample contacting component.

In one embodiment of the first aspect, the first and second interface portions are configured to make an electrical connection.

In one embodiment of the first aspect, the electrical connection is a pressure fit of the push-on/pull-off type or pull-on/push-off type.

In one embodiment of the first aspect, the electrical connection is a threaded connection of the twist-on twist-off type.

In one embodiment of the first aspect, the first interface portion comprises a plate, a biased member, a plug, a plug socket, a male portion, a female portion, or a threaded portion.

In one embodiment of the first aspect, the sample contacting component is configured to form a substantially fluid-tight and/or gas-tight connection with a mounting portion of the apparatus or system.

In one embodiment of the first aspect, the sample contacting component comprises a sealing surface or a sealing structure configured to seal with a mounting portion of the apparatus or system.

In one embodiment of the first aspect, the sample contacting component is fabricated from a material that is rigid or semi-rigid, and/or resiliently deformable.

In one embodiment of the first aspect, the sample contacting component is fabricated from a synthetic polymer.

In one embodiment of the first aspect, the sample contacting component comprises a wall that is substantially impervious to the passage of a liquid and/or a gas.

In a second aspect, there present invention provides a sample analysing apparatus or system comprising a mounting portion, the mounting portion comprising an electrical interface portion configured to make electrical connection with an electrical interface portion of a sample contacting component configured to be mounted on the mounting portion.

In one embodiment of the second aspect, the sample contacting component is a consumable, removable or interchangeable component of the sample analysing apparatus or system.

In one embodiment of the second aspect, the sample contacting component is a vessel, a liquid conduit or a probe of the sample analysing apparatus or system.

In one embodiment of the second aspect, the vessel is a tube or a well, and the liquid conduit is a pipette.

In one embodiment of the second aspect, the electrical interface portion is configured to make electrical connection with a sample contacting component.

In one embodiment of the second aspect, the electrical connection is a pressure fit electrical connection of the push-on pull-off type or pull-on/push-off type.

In one embodiment of the second aspect, the electrical connection is a threaded electrical connection of the twist-on twist-off type.

In one embodiment of the second aspect, the electrical interface portion comprises a plate, a biased member, a plug, a plug socket, a male portion, a female portion, or a threaded portion.

In one embodiment of the second aspect, the mounting portion is configured to form a substantially fluid-tight and/or gas-tight connection with a sample contacting component.

In one embodiment of the second aspect, the mounting portion comprises a sealing surface or a sealing structure configured to seal with a sample contacting component.

In one embodiment of the second aspect, the mounting portion is fabricated from a material that is rigid or semi-rigid, and/or resiliently deformable.

In one embodiment of the second aspect, the mounting portion is fabricated from a synthetic polymer.

In one embodiment of the second aspect, the mounting portion is configured to allow passage of gas therethrough so as to cause the sample contacting portion to aspirate or dispense a liquid sample.

In one embodiment of the second aspect, the apparatus or system comprises a processor having access to program instructions configured to input a current value output by an EAB sensor and transform the current output value into a clinically relevant value.

In one embodiment of the second aspect, the processor is in electrical connection with the electrical interface portion of the mounting portion.

In a third aspect, the present invention provides the combination of the sample contacting component of any embodiment of the first aspect and the apparatus or system of any embodiment of the second aspect.

In one embodiment of the third aspect, the sample contacting component is mounted on the mounting portion such that the EAB sensor is in electrical connection with the processor.

In one embodiment of the third aspect, the sample contacting component is sealingly mounted on the mounting portion.

### BRIEF DESCRIPTION OF THE FIGURES

FIG. 1 illustrates in cross-section a pipette of the present invention, having associated EAB sensor.

FIG. 2 illustrates in cross section a pipette of the present invention with a complimentary mount of a sample analysis apparatus.

FIG. 3 illustrates a stand-alone sample analysis apparatus incorporating a pipette of the present invention, having associated EAB sensor.

FIG. 4 illustrates a hand-held sample analysis apparatus incorporating a pipette of the present invention, having associated EAB sensor.

FIG. 5 illustrates exemplary connectors forming an electrical connection between a pipette and a sample analysis apparatus.

FIG. 6 illustrates a method and apparatus of the present invention for analysing multiple blood samples from a group of patients. Each patient requires assay for a different analyte.

FIG. 7 illustrates the generation of a customized pipette set from a pipette library. The customized set contains a combination of pipette types, each being capable of detecting a specific analyte by way of an associated EAB sensor.

FIG. 8 illustrates the incorporation of an EAB sensor into the floor of multi-well.

FIG. 9 illustrates the incorporation of an EAB sensor into a probe.

FIG. 10 illustrates the probe of FIG. 9 immersed in sample held within a multi-well plate.

FIG. 11 illustrates the probe of FIG. 9 immersed in sample held within a tube.

FIG. 12 illustrates a tube fitted with electrodes, and electrically connectable to the processor of a sample analysing apparatus.

FIG. 13 illustrates a system for analyte detection using a regular single use pipette in which sample is aspirated thereinto and held during analysis.

FIG. 14 illustrates a sensing head useful in the system illustrated in FIG. 13.

FIG. 15 shows a tray system useful for storing a sensing head such as that shown in FIG. 14.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers, or steps.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, “plan view” and the like are to be considered with reference to an analysis apparatus as used in a normal upright position so that liquid sample is allowed to flow downwardly under the force of gravity.

The present invention is predicated at least in part on the inventors' discovery that the use of an electrochemical aptamer-based (EAB) sensor associated with a pipette brings or other sample contacting components of a sample analysis apparatus or system brings significant advantage to the operation of same. For example, EAB sensors associated with a pipette allow for use of only a single contacting step with the sample to determine an analyte concentration. This contrasts with the lengthy multi-step test methods used by prior art high throughput apparatus and systems, making the present invention very suitable for application to analytical laboratories that process very large numbers of samples per day. Moreover, equipment requirements are drastically reduced, with some versions of the present invention allowing for high throughput processing using only a single item of equipment. As another potential advantage, workflows within a laboratory may be modified so as to more efficiently deal with the varying numbers of the different tests offered. A further advantage is that a pipette having an associated EAB sensor may be used in a point-of-care device allowing for the rapid and procedurally simple bedside determination of an analyte concentration.

An EAB sensor potentially useful in the context of the present invention may be of the potentiometric, amperometric or conductometric type. In a potentiometric sensor, a local equilibrium is established at the sensor interface, where either the electrode or membrane potential is measured, and information about a sample is derived from a potential difference between two electrodes. Amperometric sensors rely on a potential being applied between a reference and a working electrode, so as to cause the oxidation or reduction of a redox-active species; with the resultant current being measured. Conductometric sensors rely on the measurement of conductivity at a series of frequencies.

It has been found that EAB sensors are able to reliably and specifically detect a drug in a fluid of a patient. These types of sensors are typically of the amperometric type, with the aptamer (such as DNA, RNA or XNA) being bound to the working electrode. Gold is often used as the probe surface for the working electrode. The aptamer has an associated redox-active species which acts as a reporter. The redox reporter is often methylene blue. Upon target (drug) binding, the aptamer undergoes a conformational change, bringing the redox reporter more proximal to the working electrode surface. This increase in proximity increases electron transfer from the redox reporter to the electrode. The increase in speed of electron transfer contributes to a change in Faradaic current that is detected by a potentiostat.

Aptamers are small (usually from 20 to 60 nucleotides) single-stranded RNA, DNA or XNA oligonucleotides able to bind a target drug with high affinity and specificity. Aptamers may be considered as nucleotide analogues of antibodies, but aptamer production is an in vitro cell-free process that is significantly easier and cheaper than the production of antibodies by cell culture or in vivo methods.

Aptamers are usually selected from combinatorial library having a vast number (up to 10¹⁸) of different oligonucleotides. While RNA aptamers provide a significantly greater structural diversity compared to DNA aptamers, their application is complicated by stability issues in the presence of RNases, high temperature and unfavourable pH.

Selection of an aptamer that is selective for a given drug may be facilitated by a process known as SELEX (systematic evolution of ligands by exponential enrichment). The process may be considered as two alternating stages. In the first stage, the library oligonucleotides are amplified by a polymerase chain reaction (PCR) to the desired concentration. For the selection of RNA aptamers, the single-chained oligoribonucleotides are generated by in vitro transcription of double-stranded DNA with T7 RNA-polymerase. For DNA aptamers, a pool of single-stranded oligodeoxyribonucleotides is generated by strand separation of double-stranded PCR products. In the second stage, the products of amplification are incubated with target drug and oligonucleotides which bind the drug are used in the next SELEX round.

Separation of oligonucleotides with higher affinity for target drug and removal of unbound oligonucleotides are achieved through intense competition for binding sites. The selection pressure rises with every SELEX round. Maximum enrichment of the oligonucleotide pool with aptamers with the strongest affinity for the target molecule is usually achieved after 5 to 15 rounds.

EAB sensors are typically incorporated into a circuit having a reference electrode. The reference electrode is the site of a known chemical reaction that has a known redox potential. For example, a reference electrode based on the silver-silver chloride (AglAgCl) redox pair has a fixed and known potential forming the point against which the redox potential of the working electrode is measured. Also typically included in the circuit is a counter electrode which functions as a cathode or an anode to the working electrode. Because the applied voltage bias does not pass through the reference electrode (due to an impedance of the potentiostat), any potential generated is attributed to the working electrode. Current is measured as potential of the interrogating electrode versus the stable potential of the reference electrode. The difference in potential produces the current in the circuit thereby generating an output signal. The signal quantifies target binding depending on electron transfer that is ideally stoichiometrically proportional to target binding.

The present invention will now be more fully described by reference to the following non-limiting embodiments.

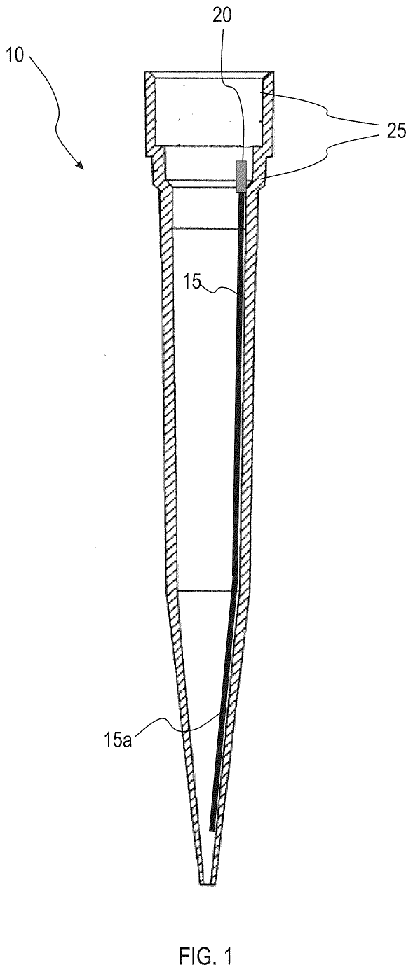

Reference is made to FIG. 1 showing an improved replaceable pipette tip (10), being a species of a sample contacting component of the present invention. The pipette tip (10) comprises a gold wire (15) running along the luminal surface of the pipette tip (10). The gold wire (15) is shown at a greatly exaggerated diameter only for the purpose of the illustration.

At its lower terminus (15a), the gold wire (15) forms the basis of a working electrode by having aptamers specific for an analyte, linked to the wire (15) surface. As described above, each aptamer has an associated redox reporter. Such means of preparing an aptamer-loaded working electrode are known to the skilled artisan. Typically, the wire (15) is functionalised with aptamer/reporter before association with the pipette (10) in a separate process.

The portion of wire (15b) that is not coated with aptamer performs the function of an electrical conduit. The wire portion (15b) has no need for exposure to a sample within the pipette (10), and in this embodiment is covered in an adhesive to secure it to the inner luminal face of the pipette (10). The adhesive maintains the wire portion (15b) in position, and according also maintains the aptamer-loaded portion (15a) in the lower part of the pipette (10) to ensure contact with sample as it resides in the pipette (10) lumen. The aptamer-load portion (15a) may be splayed away from luminal surface of the pipette (10) so as to better contact the sample.

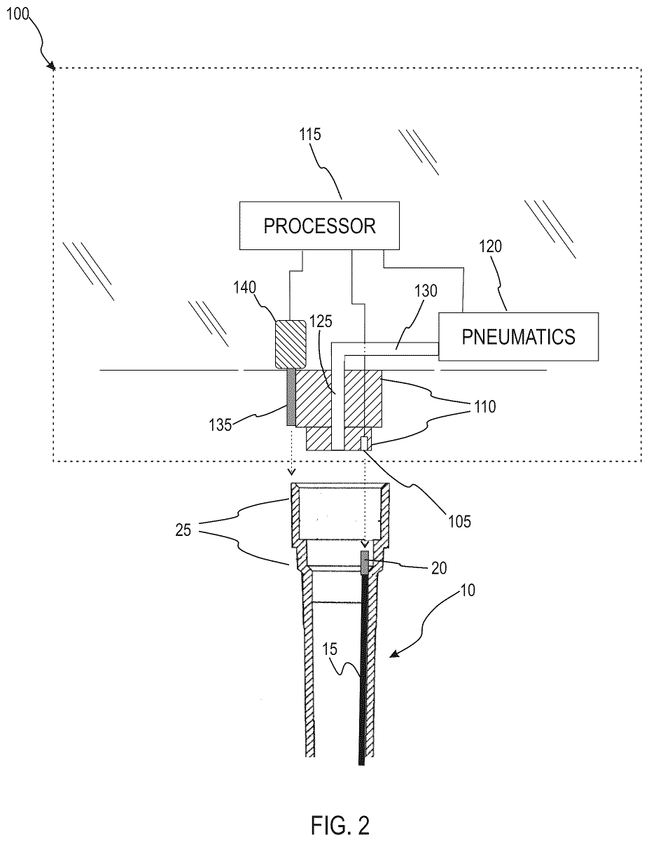

At its upper terminus, the gold wire (15) makes electrical connection to a conductive plug (20). As shown in FIG. 2, the function of the plug (20) is to connect to a socket (105) of a pipette mounting portion (110) sample analysis apparatus (100). The socket (105) in turn forms an electrical connection with a processor (115) of the sample analysis apparatus (100) by way of a pressure fit. Current arising from interrogation of the working electrode (being essentially the aptamer-coated portion (15a)) is communicated to the processor (115) where it is read as a current value and transformed into a clinically relevant value such as a target analyte concentration (as present in sample aspirated according to program instructions.

In addition to the electrical connection described above, the pipette (10) makes gaseous connection with the sample analysis apparatus (10). The upper sealing portion (25) of the pipette (10) is shaped and dimensioned so as to form a pressure fit with the complimentary pipette mounting portion (110) of the sample analysis apparatus (100). A seal is formed, allowing the pipette (10) lumen to connect to a pneumatics system (120) via a channel (125) formed in the pipette mounting portion (110) and tubing (130).

In terms of operation, the pipette (10) is mounted on the mounting portion (110) by lowering the pipette mounting portion (110) onto the pipette (10). Typically, the pipette (10) is held in a rack or other support, allowing the mounting portion (110) to resist the downward force of the mounting portion (110) so as to allow formation of a pressure fit therebetween. In many embodiments, a motor drive system under the control of program instructions executed by the processor (115) urges a head comprising multiple mounting portions downwardly, each mounting portion forming a pressure fit with its respective pipette.

When firstly mounted on the mounting portion (110) the lumen of pipette (10) is initially empty. The tip of the pipette (10) is lowered into the sample for testing and the pneumatics system (120) activated under control of program instructed executed by the processor (115) to withdraw air from the pipette (10) lumen, thereby aspirating a volume of sample into the pipette (10) lumen. The motor drive system moves the pipette (10) upwardly so as to clear the vessel holding the sample.

The aspirated sample contacts the working electrode (the aptamer-load portion 15a) where target analyte (if present) binds to the aptamer to form a current in the gold wire (15).

When interrogation of the working electrode is complete, the mounting portion is moved laterally by the motor drive system so as to be located over a waste receptacle. The pipette (10) is pushed off the mounting portion (110) by the ejector (135) being urged downwardly. The ejector (135) is urged downwardly by the solenoid (140) which is under control of program instructions executed by the processor (115). The ejector (135) is returned to its original position (as drawn) allowing the mounting portion (110) to receive a fresh pipette to perform a second run.

As will be appreciated, the working electrode requires a counter-electrode for operation. The pipette (10) will have a second wire (not drawn) with a second plug in electrical connection therewith, and the pipette mount will have a second socket (not drawn) to receive the plug.

Further, a reference electrode (based on AglAgCl for example) may be provided. In such embodiments, a third wire (not drawn) and a third plug (not drawn) are provided.

Operation of an EAB sensor requires a power supply to provide the potential required for interrogation. The power supply will typically be integral with the sample analysis apparatus (100). Means for modulating the potential, for example in a square-wave form, may be provided for, and under instruction of the processor (115).

In some embodiments, the present invention is adapted for use in a robotic high throughput sample analysis system. Such systems are capable of processing hundreds or thousands of samples per day and have high levels of automation. Typically, multiple samples are processed contemporaneously, in the formed of racked tubes or multi-well plates.

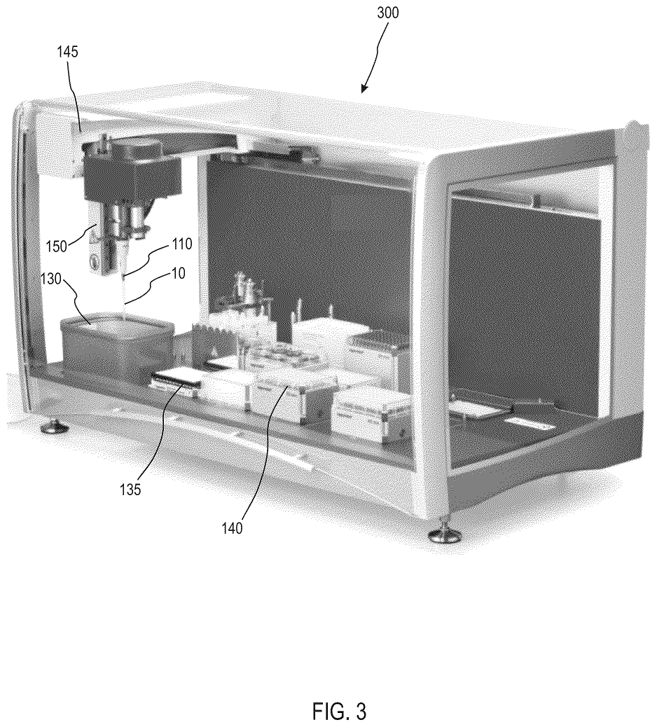

A basic bench-top robotic system (300) is illustrated in FIG. 3, showing a pipette (10) having an EAB sensor, a pipette mount (110) making gaseous and electrical connection with the pipette (10), a waste receptacle (130), a multi-well plate (135) holding multiple samples for analysis, a rack (140) holding multiple pipettes each having an EAB sensor, a first arm (145) for moving the pipette mount (110) in the x, y directions, and a second arm (150) for moving the pipette mount (110) in the z direction.

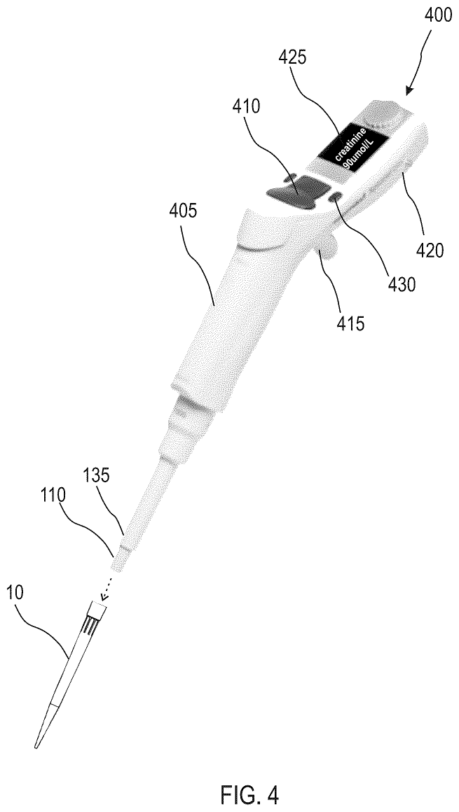

The present invention is further applicable to a portable sample analysis apparatus that can be apparatus that may be used at a point-of-care such as a doctor's office, an outpatient facility or at the bedside. Reference is made to FIG. 4 showing a hand-held apparatus (400) with a main body (405) containing a pneumatics system. In use, the main body (405) is grasped by the fingers of the user's hand, with the user's thumb resting on the button (410). The button (410) is actuated by the thumb to trigger the pneumatics system to aspirate sample through the pipette (10) when mounted. The pipette (10) has an EAB sensor, and accordingly the pipette mount (110) forms an electrical connection to the pipette (10). The pipette mount (110) further provides for gaseous connection with the pipette (10) allowing the pneumatics system to aspirate sample into the pipette. An ejector (135) is provided in the form of a slidable sleeve, which is urged downwardly by the manual depression of the ejector actuator (415). The electronics (including processor) are located within the head portion (420). The test output value is displayed on the screen (425).

The apparatus (400) comprises also a selector button (430) allowing for a user to select a certain analyte for detection. In the drawn embodiment, the apparatus has been selected to detect the metabolite creatinine. Of course, the user must select the correct pipette (10), being one with a working electrode loaded with creatinine-detecting aptamer. The selected analyte is used by the processor to determine the correct equation or standard curve to use in the generation of a clinically relevant value from a raw current value output by the EAB sensor.

The type and arrangement of the working electrode may of course differ to that shown in the drawings. In one embodiment, the electrode may be in the form of a wire, a liner, a foil, a plate, a grid, a cage, a pin, or a needle. The working electrode may be associated with the pipette wall in some way, or in other embodiments may be located centrally within the pipette lumen. In other embodiments, the working electrode extends through the pipette wall and into the lumen, with the electrical conduit running outside the pipette wall or even embedded in the pipette wall.

The plug and socket electrical connection between the pipette and the mounting portion are clearly exemplary only. Having the benefit of the present specification the skilled person will find other arrangements to be at least operable in the context of the invention. For example, two opposed conductive plates may be used (optionally spring-loaded), or a system comprising a rigid member biased member (similar to a mains electrical outlet).

Connector arrangements which obviate the need for the pipette to be rotated axially into any specific position to allow for connection to the mounting portion will be generally preferred. In many embodiments, three separate electrical connections will be needed, one for each of the working, reference, and counter electrodes. Thus, it would be desirable for the pipette to be connectable to the mounting portion in any axial rotation, and still function.

In some embodiments, a guide system is implemented to axially rotate the pipette to a predetermined position as the pipette is moved onto the pipette mount such that connectors are correctly aligned.

In some embodiments, the processor is configured to detect which connector of the mounting portion is connected to which electrode (i.e., working, counter or reference electrode). As one example, each connector on the mounting portion may have a light sensitive optical detector adjacent thereto configured to measure the reflectance of a surface (coloured white, grey, or black) adjacent to a connector on the pipette.

In another example, the processor is configured to determine an inherent electrical characteristic that is diagnostic of which connector (on the pipette side) is connected.

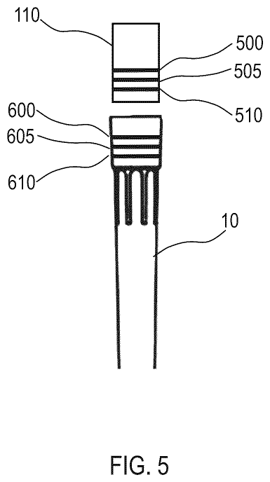

In yet a further example, and in reference to FIG. 5, the connections are in the form of annular conductive tracks disposed on the external surface of the pipette mount (500, 505, 510) and complimentary annular conductive tracks disposed on the internal surface of the pipette (600, 605, 610). Connectors (500), (505) and (510) are connected respectively to the processor inputs for the working, counter, and reference electrodes. Connectors (600), (605) and (610) are connected respectively to the working, counter, and reference electrodes. When the pipette (10) is fully seated on the mounting portion (110), the connectors align (500 with 600, 505 with 605, and 510 with 610) such that the correct connections between the electrode and processor inputs are inevitably made.

An apparatus of the present invention (however embodied) typically comprises a potentiostat to control the potential applied to the working electrode.

The use of a pipette having an associated EAB sensors allows for apparatuses that are self-contained and capable of performing a broad range analyte detection methods without the need for further equipment. Moreover, the apparatuses may detect target analyte by a single step of contacting a sample to an EAB sensor.

In this exemplary workflow a number of subjects (715, 725, 735, . . . n) each provides a blood sample into a vacutainer (720, 730, 740) for analysis of an analyte such as a drug, a metabolite, or an antibody of a certain specificity. An aliquot of blood from each vacutainer (720, 730, 740) is placed into a well of a 96-well multi-well plate (745), at one aliquot per well.

The multi-well plate (745) is mounted on a tray (750) of the high throughput analyte detection apparatus (710). The apparatus (710) comprises an array of pipettes having associate EAB sensors (not visible in FIG. 1, but marked 10 elsewhere) arranged in a 12×8 grid, and in register with the wells of the multi-well plate (745). As will be more fully described below, the array of pipettes is initially disposed above the multi-well plate (745) and for analysis are lowered into the wells of the multi-well plate (745), at which time sample from each well is aspirated into the respective pipette lumen where contact with an EAB sensor is made.

After the aptamer-based biosensor is interrogated, the analyte concentration for each subject (715, 720, 725) is displayed on a screen (755) for review by an operator if need be.

The analyte concentration for each subject (715, 720, 725) is transmitted as an electronic file, data packet or otherwise to a laboratory server (800) and stored on a relational database (805) of the relevant analytical sample laboratory. The analyte concentration is stored in linked association with an identifier such as the relevant subject's name (optionally with date of birth) or other unique identifier such as health insurance number, social security number patient number, or similar.

At the conclusion of the analysis, the multi-well plate (745) is removed from the tray (750) is discarded.

The pipette tips are removable from the high throughput analyte detection apparatus (700), and these are also discarded.

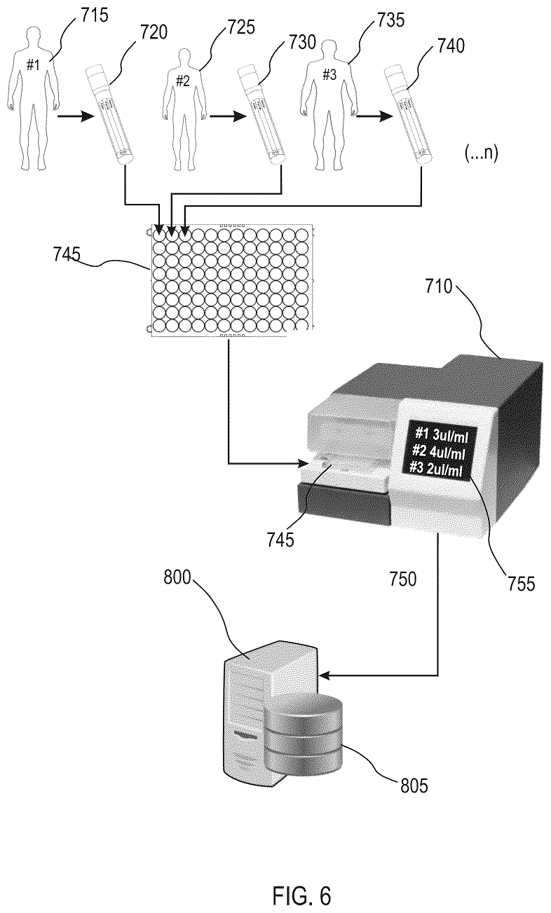

FIG. 6 illustrates the generation of a customized pipette set from a pipette library. The customized set contains a combination of pipette types, each being capable of detecting a specific analyte by way of an associated EAB sensor.

In preparation for the next analysis, a new set of pipette tips are installed on the high throughput analyte detection apparatus (710). The particular set of tips selected will depend on the analyte to be detected on the next analysis. For example, where the target analyte is troponin, each pipette of the set has an aptamer that is specific for troponin.

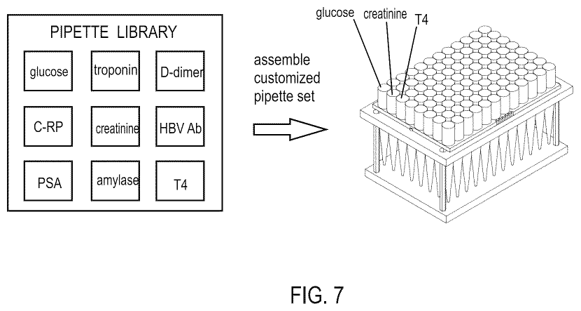

The analytical laboratory or point-of-care may have a “library” of pipettes, from which an operator (or even a machine) may select according to the desired analyte. In some circumstances, pipettes specific for different analytes may be mixed to form a set of pipettes. Reference is made to FIG. 7. For example, each sample may be tested for troponin and creatinine phosphokinase in which case each subject's blood is disposed in two wells with the contents of the first well being aspirated into a troponin-sensing pipette and contents of the second well being aspirated into a creatinine phosphokinase-sensing pipette. As an alternative, a single pipette may comprise aptamers capable of sensing more than one analyte.

A mixed set of pipettes may be used where each subject requires analysis for a single target analyte, but two different analyte runs are to be performed on a single multi-well plate. For example, a first group of subjects may require analysis for glucose and a second group of subjects require analysis for testosterone. In that case the multi-well plate may be divided one half for glucose and the other half for testosterone.

As will be appreciated from the above, the use of aptamer-loaded pipettes provides for significant flexibility in the operation of an analysis laboratory. A highly customised set of pipettes may form allowing for multiple selected analytes to be assayed for on a single multi-well plate.

The use of aptamer-based biosensors in association with a pipette allows for the customisations described above. For many prior art assays, the analytical methods involved are very different thereby preventing the ability to run different assays on the same plate or rack of tubes. For example, one method may be an enzyme-linked immunosorbent assay comprising multiple steps, while another may be reliant on a magnetic bead technology. The very different process steps prevent prior art assays from being executed together. By contrast, aptamer-based detection methods may rely on only a single contacting step irrespective of the target analyte. For example, the contacting step may be effected by simply aspirating sample into a pipette such that sample contacts the aptamers within the pipette lumen. At that point the biosensor is interrogated by the application of potential (such as by square-wave voltammetry) and a reliable current output proportional to the amount of analyte present is provided in seconds.

The use of a single contacting step allows significant time savings which dramatically improve the throughput of an analytical laboratory, and also simplify point-of-care analyte detection. By negating the need for washing steps, use of multiple reagents at different times of the detection method, transferring sample between items or equipment and the like-can get through thousands. In this exemplary workflow, a 96-well micro-well plate is used allowing for about 60, 70 or 80 samples to be analysed (a number of wells typically being reserved for use as controls, generation of a standard curve etc).

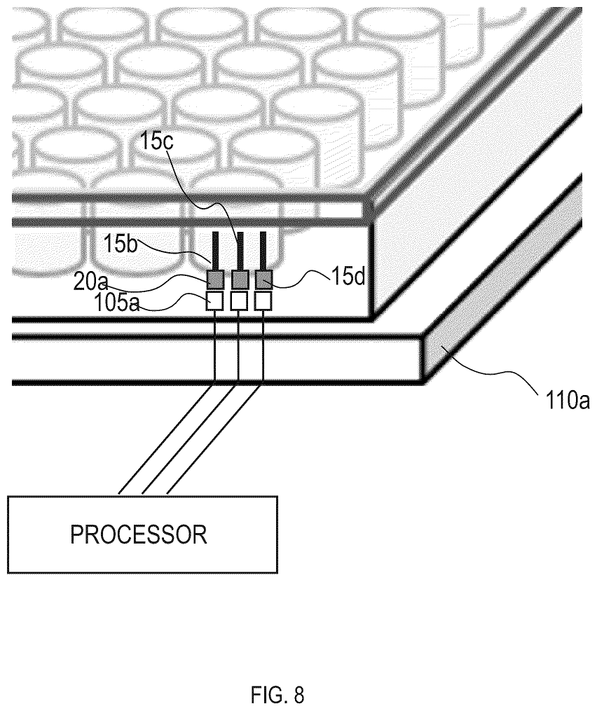

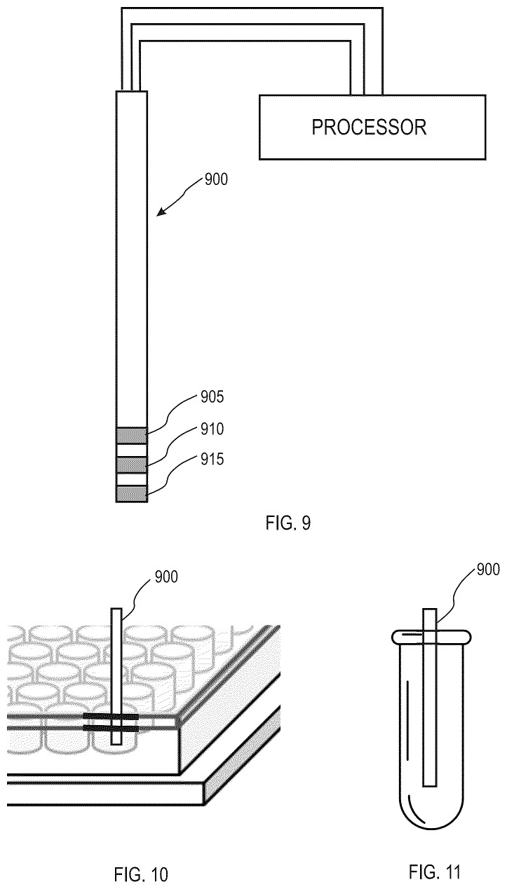

Apart from pipettes, and EAB sensor may be associated with the well of a multi-well plate (45). FIG. 8 shows three wires (15b, 15c, 15d) being respectively interrogating (aptamer-loaded), counter and reference electrodes extending into the well. Each wire has a connector (one marked 20a) incorporated into the floor of the well. The plate holder (110a) has a complimentary set of connectors (one marked 105a) forming an electrical connection with well connectors (20a). Conduit from each of the well connectors (20a) connect to the processor.

In another alternative, an aptamer-load probe (900) is provided, which may contact sample held in a multi-well plate (FIG. 10), or a tube (FIG. 11). The probe (900) in this embodiment is made of an electrically insulating material to isolate the conductive rings (905, 910, 915). The ring (905) is loaded with aptamer and is the working electrode, the ring (910) is the counter electrode, and the ring (915) is the reference electrode.

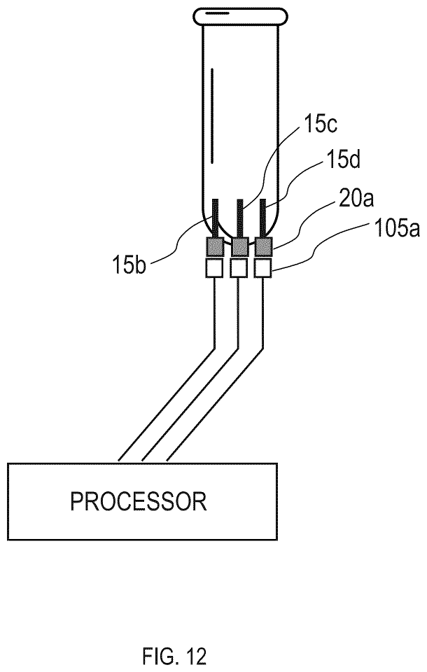

FIG. 12 shows a tube having associated working electrode (15b), reference electrode (15c) and counter electrode (15d). the tube connectors (one marked 20a) make electrical connection with tube rack connectors (one marked 105a).

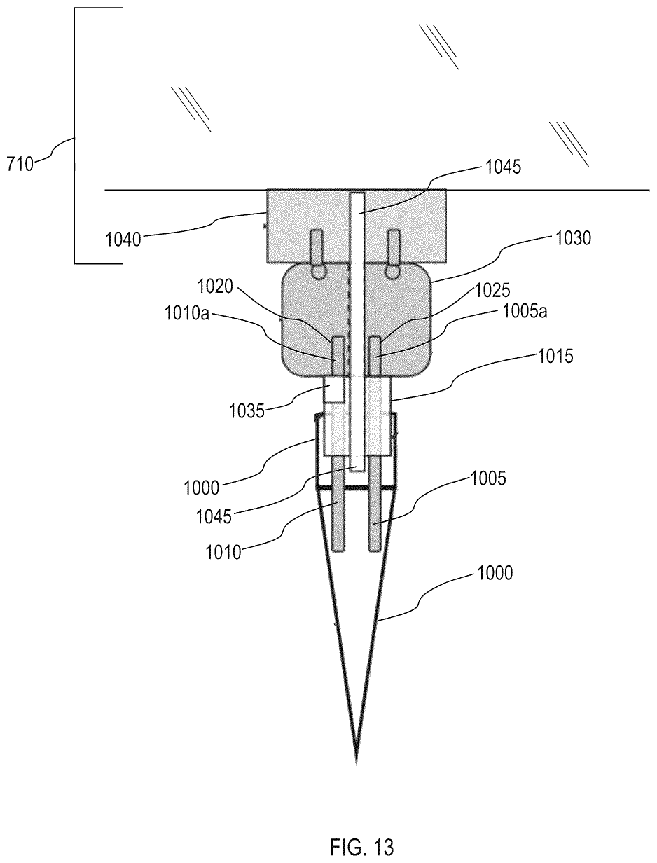

FIG. 13 shows an embodiment similar to the earlier described pipette-based embodiments, however using a regular disposable pipette (1000). The analyte detection apparatus (710) may provide some or all required electrical componentry with the pipette serving only the purpose of holding the test sample in contact with the electrodes during analysis.

In the embodiment of FIG. 13, the analyte detection apparatus provides the aptamer-load electrode and counter electrode in the form of pins (1005, 1010). The pins (1005, 1010) are moulded into a barrel (1015) to provide a unitary sense head. The diameter of the barrel (1015) is dimensioned so as to form a pressure fit with the pipette (1000).

The pins (1005, 1010) extend beyond the upper surface of the barrel (1015) to provide connecting portions (1005a, 1010a) which make electrical connection with electrical sockets (1020, 1025) in an intermediate portion (1030). The electrical connection so formed may maintain the barrel (1015) together with the intermediate portion (1030). Alternatively, a pressure fit between the other portions of the barrel (1015) and the intermediate portion (1030) may be implemented. Magnetic connection will also be a useful alternative.

A key arrangement (1035) comprising a protrusion in one part and a complimentary recess in another part may be incorporated to ensure correct connection between the barrel (1015) and the intermediate portion (1030). The key arrangement may also be used to provide a pressure fit keeping the barrel (1015) and the intermediate portion (1030) together.

An apparatus interface portion (1040) is a permanent part of the apparatus (710), forming electrical connection with the intermediate portion (1030) and in turn the electrode pins (1005, 1010). The apparatus interface portion (1040) forms the electrical connection interface of the apparatus (710). The apparatus interface portion (1040) provides an aspiration tube (1045) which is configured to pass through the intermediate portion (1030) and the barrel (1015) to provide gaseous communication between the pipette (1000) lumen and a pneumatic system (not drawn) of the analyte detection apparatus (710).

In this embodiment, the pipette (100) is typically for single use only.

The electrode pins (1005, 1010) and barrel (1015) may be used 5, 10, 20, 30, 40, 50, 60, 70, 80, 90, 100 times or more. The aptamers on the working electrode pin (1005) may be purged of bound species from a previous sample by a simple washing step, or by passing an electrical current therethrough.

The intermediate portion (1030) may be used multiple times, but may require replacement when worn and unable to form any require pressure fit, electrical connection or other required function. Advantageously, the intermediate portion (1030) is a serviceable part of the apparatus (710), replaceable by a technician or even a non-expert user.

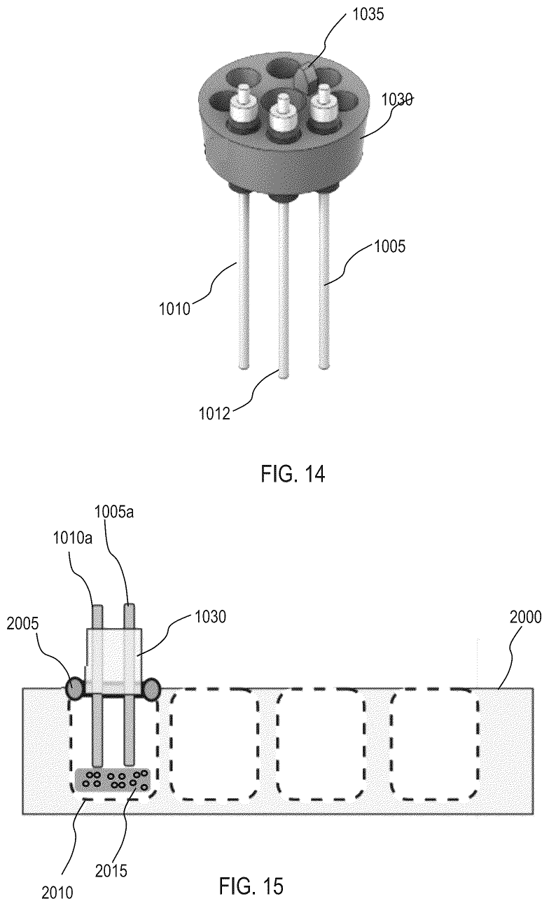

Reference is made to FIG. 14 showing the isolated sense head, with a third electrode pin (1012) being a reference electrode. As will be noted, spaces exist to allow for the incorporation of further working electrodes, each of which is loaded with aptamers for the detection of the further analytes.

The aptamers in electrochemical sensors are labile, and consideration may be given to means by which a newly manufactured electrode set is stored ready for use. A general aim is to provide storage conditions that are dry and substantially oxygen-free. It will also be preferable that the electrodes are stored in a manner that allows for easy connection to a sample analyte apparatus.

Having regard to the requirements above the storage system of FIG. 15 is proposed, comprising a tray (2000) having multiple recesses (one marked 2005) each configured to receive and hold a sensing head (1005, 1010, 1015). The sensing head (1005, 1010, 1015) is oriented such that the electrode pin portions (1005a, 1005b) which extend beyond the barrel (1030) are directed upwardly, and are therefore accessible to a complimentary connector being located directly above and moved downwardly theretowards.

The barrel (1030) is fitted with an annular seal (2010) that may be an O-ring or an over-moulded gasket which functions to seal against the upper inner wall of the recess (2005), thereby isolating aptamer coated on the lower terminus of the working electrode pin (1005) from the atmosphere.

The sensing head (1005, 1010, 1015) may be disposed in the tray (2000) and sealed against the recess (2010) wall under oxygen free and moisture free conditions. For example, the tray (2000) may be populated with sensing heads in an environment of dry nitrogen gas. In addition, or alternatively, each recess (2010) may comprise a perforated receptacle desiccant (such as silica gel) and an oxygen absorber (such as an iron powder).

The present invention is amenable to computer-implementation given the output of an EAB sensor is an electrical signal that may be electronically stored as a numerical value (e.g., an electrical current value) in volatile memory, and be manipulated and analysed by an associated processor under the instruction of software.

As will be appreciated by the skilled artisan, the present invention may be deployed in part or in whole through one or more processors that execute computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon.

In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor or a mobile device or server may access a storage medium through an interface that may store methods, codes, and instructions as described herein and elsewhere. The storage medium associated with the processor for storing methods, programs, codes, program instructions or other types of instructions capable of being executed by the computing or processing device may include solid state memory and hard disk memory.

A processor may include one or more cores that may enhance speed and performance of a multiprocessor. In some embodiments, the processor may be a dual core processor, quad core processor, other chip-level multiprocessor and the like that combine two or more independent cores (called a die).

The methods and systems described herein may be deployed in part or in whole through one or more hardware components that execute software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium. The processes, methods, program codes, instructions described herein and elsewhere may be executed by one or more of the network infrastructural elements.

The methods, program codes, calculations, algorithms, and instructions described herein may be implemented on a cellular network having multiple cells. The cellular network may include mobile devices, cell sites, base stations, repeaters, antennas, towers, and the like. The cell network may be a GSM, GPRS, 3G, 4G, 5G, EVDO, mesh, or other network types.

The methods, programs codes, calculations, algorithms and instructions described herein may be implemented on or through mobile devices. The mobile devices may include cell phones, mobile personal digital assistants, laptops, palmtops, netbooks, pagers, electronic book readers and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include computer components, devices, and recording media that retain digital data used for computing for some interval of time; storage known as random access memory (RAM); mass storage typically for more permanent storage, such as optical discs, forms of magnetic storage like hard disks.

The methods and systems described herein may transform physical and/or or intangible items from one state to another. The methods and systems described herein may also transform data representing physical and/or intangible items from one state to another.

The elements described and depicted herein may imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Furthermore, the elements depicted may be implemented on a machine capable of executing program instructions. Thus, while the present descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realised in hardware, software or any combination of hardware and software suitable for a particular application. The hardware may include a general purpose computer and/or dedicated computing device or specific computing device or particular aspect or component of a specific computing device. The processes may be realised in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realised as a computer executable code capable of being executed on a computer readable medium.

The application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionalities may be integrated into a dedicated, standalone device or other hardware. In another aspect, the means for performing the steps associated with the processes described above may include any of the hardware and/or software described above. All such permutations and combinations are intended to fall within the scope of the present disclosure.

Any of the methods disclosed herein may be performed by application software executable on any past, present or future operating system of a processor-enabled device such as Windows™, Linux™, Android™, iOS™, and the like. It will be appreciated that any software may be distributed across a number of devices or in a “software as a service” format, or “platform as a service” format whereby participants require only some computer-based means of engaging with the software.

The present invention has been described by reference mainly to the analysis of clinical samples taken from a human subject. It will be appreciated that the invention is applicable to other applications requiring high throughput testing of samples for one or more analytes, including but not limited to veterinary medicine, agriculture, scientific research, quality control and quality assurance in manufacturing environments, food safety, and the analysis of environmental samples such as water and soil.

Those skilled in the art will appreciate that the invention described herein is susceptible to further variations and modifications other than those specifically described. It is understood that the invention comprises all such variations and modifications which fall within the spirit and scope of the present invention.

Accordingly, the spirit and scope of the present invention is not to be limited by the foregoing examples, but is to be understood in the broadest sense allowable by law.

1. A sample contacting component of a sample analysing apparatus or system, the sample contacting component comprising:
an electrochemical aptamer-based sensor associated therewith configured to contact a sample within or about the sensor.

2. The sample contacting component of claim 1 that is a consumable, removable or interchangeable component of a sample analysing apparatus or system.

3. The sample contacting component of claim 1 that is a vessel, a liquid conduit or a probe of a sample analysing apparatus or system.

4. The sample contacting component of claim 3, wherein the vessel is a tube or a well, and the liquid conduit is a pipette.

5. The sample contacting component of claim 1, wherein the electrochemical aptamer-based sensor comprises a working electrode.

6. (canceled)

7. The sample contacting component of claim 5, comprising an electrical conduit in electrical connection with the working electrode.

8. The sample contacting component of claim 7, wherein the electrical conduit extends from the working electrode to an edge of the component.

9. The sample contacting component of claim 7, wherein the electrical conduit has a terminus distal to the working electrode and the terminus forms a first interface portion or is in electrical connection with a first interface portion, the first interface portion being configured to make electrical connection with a second interface portion of a mounting component of the apparatus or system, the mounting component being configured as a mount for the sample contacting component, and wherein the first and second interface portions are configured to make an electrical connection.

10. (canceled)

11. The sample contacting component of claim 10, wherein the electrical connection is a pressure fit of the push-on/pull-off type or pull-on/push-off type, or a threaded connection of the twist-on twist-off type.

12. (canceled)

13. (canceled)

14. The sample contacting component of claim 9, configured to form a substantially fluid-tight and/or gas-tight connection with a mounting portion of the apparatus or system.

15. (canceled)

16. (canceled)

17. (canceled)

18. (canceled)

19. A sample analysing apparatus or system comprising:
a mounting portion, the mounting portion comprising an electrical interface portion configured to make electrical connection with an electrical interface portion of a sample contacting component configured to be mounted on the mounting portion.

20. The apparatus or system of claim 19, wherein the sample contacting component is a consumable, removable or interchangeable component of the sample analysing apparatus or system.

21. The apparatus or system of claim 19, wherein the sample contacting component is a vessel, a liquid conduit or a probe of the sample analysing apparatus or system.

22. The apparatus or system of claim 21, wherein the vessel is a tube or a well, and the liquid conduit is a pipette.

23. The apparatus or system of claim 19, wherein the electrical interface portion is configured to make electrical connection with a sample contacting component.

24. (canceled)

25. (canceled)

26. (canceled)

27. The apparatus or system of claim 19, wherein the mounting portion is configured to form a substantially fluid-tight and/or gas-tight connection with a sample contacting component.

28. The apparatus or system of claim 27, wherein the mounting portion comprises a sealing surface or a sealing structure configured to seal with a sample contacting component.

29. (canceled)

30. (canceled)

31. The apparatus or system of claim 19, wherein the mounting portion is configured to allow passage of gas therethrough so as to cause the sample contacting portion to aspirate or dispense a liquid sample.

32. The apparatus or system of claim 19, comprising a processor having access to program instructions configured to input a current value output by an electrochemical aptamer-based sensor and transform the current output value into a clinically relevant value.

33. The apparatus or system of claim 32, wherein the processor is in electrical connection with the electrical interface portion of the mounting portion.

34. (canceled)

35. (canceled)

36. (canceled)
